(19) United States
(12) Patent Application Publication
(10) Pub. No.: US 2026/0067053 A1
(43) Pub. Date: Mar. 5, 2026

(54) FREQUENCY-TRANSLATED BACKSCATTER MODULATION FOR AMBIENT POWER TAGS

(71) Applicant: QUALCOMM Incorporated, San Diego, CA (US)

(72) Inventors: Manideep DUNNA, San Jose, CA (US); Bin TIAN, San Diego, CA (US); Stephen Jay SHELLHAMMER, Ramona, CA (US); Youhan KIM, Saratoga, CA (US)

(21) Appl. No.: 19/312,711

(22) Filed: Aug. 28, 2025

Related U.S. Application Data
(60) Provisional application No. 63/690,708, filed on Sep. 4, 2024.

(51) Int. Cl. H04L 5/00

(52) U.S. Cl. CPC H04L 5/0094

(57) ABSTRACT

This disclosure provides methods, components, devices and systems for frequency-translated backscatter modulation for ambient power (AMP) tags. In some examples, a user equipment (UE) may transmit an excitation signal to an AMP tag via a first subchannel of a channel bandwidth. The AMP tag may transmit a backscattered tag response to the UE via a second subchannel of the channel bandwidth based on receiving the excitation waveform. In some examples, the AMP tag may modulate information with the backscattered tag response by translating the excitation signal to the second subchannel such that the backscattered tag response does not interfere with the excitation waveform. The second subchannel that includes the backscattered tag response may indicate one or more information bits associated with the backscattered tag response. The UE may decode information bits from the backscattered tag response using an energy detection operation.

### CROSS REFERENCES

The present Application for patent claims the benefit of U.S. Provisional Patent Application No. 63/690,708 by DUNNA et al., entitled “FREQUENCY-TRANSLATED BACKSCATTER MODULATION FOR AMBIENT POWER TAGS,” filed Sep. 4, 2024, assigned to the assignee hereof, and which is expressly incorporated in its entirety herein.

### TECHNICAL FIELD

This disclosure relates generally to wireless communication and, more specifically, to frequency-translated backscatter modulation for ambient power tags.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

A method for wireless communications by a wireless device is described. The method may include receiving an excitation waveform via a first subchannel of a set of multiple subchannels of a channel bandwidth and outputting a backscattered response waveform via a second subchannel of the set of multiple subchannels of the channel bandwidth based on the excitation waveform, where the backscattered response waveform is based on a frequency translation of signal energy of the excitation waveform from the first subchannel to the second subchannel, and where the frequency translation from the first subchannel to the second subchannel indicates one or more information bits.

A wireless device for wireless communications is described. The wireless device may include one or more memories storing processor executable code, and one or more processors coupled with the one or more memories. The one or more processors may individually or collectively be operable to execute the code to cause the wireless device to receive an excitation waveform via a first subchannel of a set of multiple subchannels of a channel bandwidth and output a backscattered response waveform via a second subchannel of the set of multiple subchannels of the channel bandwidth based on the excitation waveform, where the backscattered response waveform is based on a frequency translation of signal energy of the excitation waveform from the first subchannel to the second subchannel, and where the frequency translation from the first subchannel to the second subchannel indicates one or more information bits.

Another wireless device for wireless communications is described. The wireless device may include means for receiving an excitation waveform via a first subchannel of a set of multiple subchannels of a channel bandwidth and means for outputting a backscattered response waveform via a second subchannel of the set of multiple subchannels of the channel bandwidth based on the excitation waveform, where the backscattered response waveform is based on a frequency translation of signal energy of the excitation waveform from the first subchannel to the second subchannel, and where the frequency translation from the first subchannel to the second subchannel indicates one or more information bits.

A non-transitory computer-readable medium storing code for wireless communications is described. The code may include instructions executable by one or more processors to receive an excitation waveform via a first subchannel of a set of multiple subchannels of a channel bandwidth and output a backscattered response waveform via a second subchannel of the set of multiple subchannels of the channel bandwidth based on the excitation waveform, where the backscattered response waveform is based on a frequency translation of signal energy of the excitation waveform from the first subchannel to the second subchannel, and where the frequency translation from the first subchannel to the second subchannel indicates one or more information bits.

In some examples of the method, wireless devices, and non-transitory computer-readable medium described herein, each subchannel of the set of multiple subchannels other than the first subchannel may be associated with one or more information bit values.

In some examples of the method, wireless devices, and non-transitory computer-readable medium described herein, the frequency translation from the first subchannel to the second subchannel may be an increase in frequency that may be associated with a first value for an information bit of the one or more information bits or a decrease in frequency that may be associated with a second value for an information bit of the one or more information bits.

In some examples of the method, wireless devices, and non-transitory computer-readable medium described herein, each subchannel of the set of multiple subchannels corresponds to a different resource unit of a set of multiple resource units included within the channel bandwidth.

In some examples of the method, wireless devices, and non-transitory computer-readable medium described herein, outputting the backscattered response waveform may include operations, features, means, or instructions for outputting the backscattered response waveform at a first signal energy level that may be one of a set of multiple different signal energy levels, where each signal energy level of the set of multiple different signal energy levels corresponds to a different value for an information bit of the one or more information bits.

Some examples of the method, wireless devices, and non-transitory computer-readable medium described herein may further include operations, features, means, or instructions for receiving the excitation waveform via the first subchannel over a set of multiple transmission time intervals (TTIs) and outputting the backscattered response waveform into at least one subchannel of the set of multiple subchannels other than the first subchannel during a time duration associated with the set of multiple TTIs to indicate a sequence of the one or more information bits.

Some examples of the method, wireless devices, and non-transitory computer-readable medium described herein may further include operations, features, means, or instructions for transmitting a training sequence associated with an amplitude of the backscattered response waveform, where an amplitude threshold associated with a first bit value of the one or more information bits may be based on the training sequence.

In some examples of the method, wireless devices, and non-transitory computer-readable medium described herein, the excitation waveform may be received via the first subchannel that may be a single subchannel of the set of multiple subchannels of the channel bandwidth and the backscattered response waveform may be backscattered in the second subchannel that may be any subchannel of the set of multiple subchannels other than the first subchannel.

A method for wireless communications by a user equipment (UE) is described. The method may include transmitting an excitation waveform via a first subchannel of a set of multiple subchannels of a channel bandwidth and receiving a backscattered response waveform via a second subchannel of the set of multiple subchannels of the channel bandwidth, where the backscattered response waveform is based on a frequency translation of signal energy of the excitation waveform from the first subchannel to the second subchannel, and where the frequency translation from the first subchannel to the second subchannel indicates one or more information bits.

A UE for wireless communications is described. The UE may include one or more memories storing processor executable code, and one or more processors coupled with the one or more memories. The one or more processors may individually or collectively be operable to execute the code to cause the UE to transmit an excitation waveform via a first subchannel of a set of multiple subchannels of a channel bandwidth and receive a backscattered response waveform via a second subchannel of the set of multiple subchannels of the channel bandwidth, where the backscattered response waveform is based on a frequency translation of signal energy of the excitation waveform from the first subchannel to the second subchannel, and where the frequency translation from the first subchannel to the second subchannel indicates one or more information bits.

Another UE for wireless communications is described. The UE may include means for transmitting an excitation waveform via a first subchannel of a set of multiple subchannels of a channel bandwidth and means for receiving a backscattered response waveform via a second subchannel of the set of multiple subchannels of the channel bandwidth, where the backscattered response waveform is based on a frequency translation of signal energy of the excitation waveform from the first subchannel to the second subchannel, and where the frequency translation from the first subchannel to the second subchannel indicates one or more information bits.

A non-transitory computer-readable medium storing code for wireless communications is described. The code may include instructions executable by one or more processors to transmit an excitation waveform via a first subchannel of a set of multiple subchannels of a channel bandwidth and receive a backscattered response waveform via a second subchannel of the set of multiple subchannels of the channel bandwidth, where the backscattered response waveform is based on a frequency translation of signal energy of the excitation waveform from the first subchannel to the second subchannel, and where the frequency translation from the first subchannel to the second subchannel indicates one or more information bits.

In some examples of the method, UEs, and non-transitory computer-readable medium described herein, each subchannel of the set of multiple subchannels other than the first subchannel may be associated with one or more information bit values.

In some examples of the method, UEs, and non-transitory computer-readable medium described herein, the frequency translation from the first subchannel to the second subchannel may be an increase in frequency that may be associated with a first value for an information bit of the one or more information bits or a decrease in frequency that may be associated with a second value for an information bit of the one or more information bits.

In some examples of the method, UEs, and non-transitory computer-readable medium described herein, each subchannel of the set of multiple subchannels corresponds to a different resource unit of a set of multiple resource units included within the channel bandwidth.

Some examples of the method, UEs, and non-transitory computer-readable medium described herein may further include operations, features, means, or instructions for transmitting the excitation waveform via the first subchannel over a set of multiple TTIs and receiving the backscattered response waveform via at least one subchannel of the set of multiple subchannels other than the first subchannel during a time duration associated with the set of multiple TTIs to indicate a sequence of the one or more information bits.

Some examples of the method, UEs, and non-transitory computer-readable medium described herein may further include operations, features, means, or instructions for decoding a value of an information bit of the one or more information bits from the backscattered response waveform based on a comparison of energy detected for the second subchannel relative to energy detected for one or more other subchannels of the set of multiple subchannels other than the first subchannel.

Some examples of the method, UEs, and non-transitory computer-readable medium described herein may further include operations, features, means, or instructions for calculating an energy of the second subchannel and an energy of the one or more other subchannels based on a summation of one or more squares of one or more respective subcarrier amplitudes of the second subchannel and the one or more other subchannels.

In some examples of the method, UEs, and non-transitory computer-readable medium described herein, each subchannel of the set of multiple subchannels other than the first subchannel corresponds to a value of the one or more information bits in accordance with a bit mapping and the second subchannel may be associated with a highest subchannel energy of the set of multiple subchannels other than the first subchannel.

Some examples of the method, UEs, and non-transitory computer-readable medium described herein may further include operations, features, means, or instructions for decoding a value of an information bit of the one or more information bits from the backscattered response waveform based on a comparison of an amplitude of the backscattered response waveform received via the second subchannel to a threshold.

Some examples of the method, UEs, and non-transitory computer-readable medium described herein may further include operations, features, means, or instructions for receiving a training sequence, where the threshold may be based on the training sequence.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example of a signaling diagram that supports frequency-translated backscatter modulation for ambient power tags.

FIG. 3 shows an example of a mapping scheme that supports frequency-translated backscatter modulation for ambient power tags.

FIG. 4 shows an example of an amplitude modulation scheme that supports frequency-translated backscatter modulation for ambient power tags.

FIG. 5 shows an example of a process flow that supports frequency-translated backscatter modulation for ambient power tags.

FIG. 6 shows a block diagram of an example wireless device that supports frequency-translated backscatter modulation for ambient power tags.

FIG. 7 shows a block diagram of an example user equipment (UE) that supports frequency-translated backscatter modulation for ambient power tags.

FIG. 8 shows a flowchart illustrating an example process performable by or at a wireless device that supports frequency-translated backscatter modulation for ambient power tags.

FIG. 9 shows a flowchart illustrating an example process performable by or at a user equipment (UE) that supports frequency-translated backscatter modulation for ambient power tags.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) Multiple-Input Multiple-Output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Some wireless communications networks may include a user equipment (UE) in communication with an ambient power (AMP) device. AMP devices may be associated with low-power and low-cost operation, for example, by implementing energy harvesting techniques. In some examples, wireless communications systems may implement AMP devices as low-power tags for applications such as inventory management and self-checkout procedures. Such AMP tags may communicate with an AMP reader, such as a radio-frequency identification (RFID) reader. However, RFID readers may be large and expensive, which may impact the accessibility of using AMP tags. Accordingly, it may be beneficial to integrate AMP readers into consumer devices (e.g., UEs), such as a smartphone, to reduce the size and cost of the AMP readers (e.g., AMP reader hardware) and to increase accessibility. However, existing UE hardware architecture may limit a capability of UEs to support or implement the AMP reader. For example, transmit and receive antennas of the AMP reader may be located in close proximity, and a high-power signal transmitted by the AMP reader, such as an excitation signal, may overpower received signaling from the AMP tag, such as a tag response. In such examples, modifying the hardware architecture of the UE to support the AMP reader, such as by including a self-interference canceller, may not be cost-effective.

Various aspects of the present disclosure are related to frequency-translated backscattering modulation for ambient power tags. In some examples, a UE may transmit an excitation waveform to an AMP tag via a wireless channel (e.g., a channel bandwidth). The UE may transmit the excitation waveform in a first subchannel of the channel bandwidth and may leave the remaining subchannels of the channel bandwidth empty. The AMP tag may transmit a backscattered tag response to the UE via a second subchannel of the channel bandwidth based on receiving the excitation waveform. In some examples, the AMP tag may modulate information bits with the tag response by applying a frequency shift to the excitation waveform to translate the backscattered tag response to the second subchannel such that the backscattered tag response does not interfere with the excitation waveform. The AMP tag may implement a frequency-shift keying (FSK) modulation scheme or an on-off keying (OOK) modulation scheme. In some cases, the second subchannel that includes the backscattered tag response may indicate one or more information bits associated with the backscattered tag response.

The UE may decode the one or more information bits from the backscattered tag response in accordance with an energy detection operation. For example, the UE may measure an energy of some or all of the subchannels of the channel bandwidth to decode one or more information bits from the backscattered tag response. The UE may determine that the backscattered tag response indicates a bit value based on calculating an energy of the second subchannel. In some examples where the AMP tag modulates data with the backscattered tag response using FSK modulation, the UE may determine an information bit value indicated by the backscattered tag response based on determining that an increase or a decrease in frequency was applied to the backscattered tag response in accordance with the energy detection operation. Additionally, or alternatively, the UE may decode multiple information bit values from the backscattered tag response based on the frequency shift applied to the second subchannel and a bit mapping. The bit mapping may correlate each subchannel other than the first subchannel to multiple bit values based on the number of subchannels of the channel bandwidth. In some other examples where the AMP tag modulates the data with the backscattered tag response using OOK modulation, the UE may determine an information bit value indicated by the backscattered tag response based on comparing an energy (e.g., an amplitude) of the backscattered tag response to a threshold in accordance with the energy detection operation.

Particular aspects of the subject matter described in this disclosure can be implemented to realize one or more of the following potential advantages. In some examples, by applying the frequency shift to the excitation waveform such that the backscattered tag response is communicated in a subchannel separate from the excitation signal, the described techniques can be used to reduce interference (e.g., self-interference) at the UE, which may further reduce complexity at the UE by allowing the UE to support communications with an AMP tag without modifying existing UE receiver architecture. Additionally, in some examples where the backscattered tag response indicates multiple information bit values in accordance with the FSK modulation scheme and the bit mapping, the described techniques can be used to improve a data rate of the AMP tag.

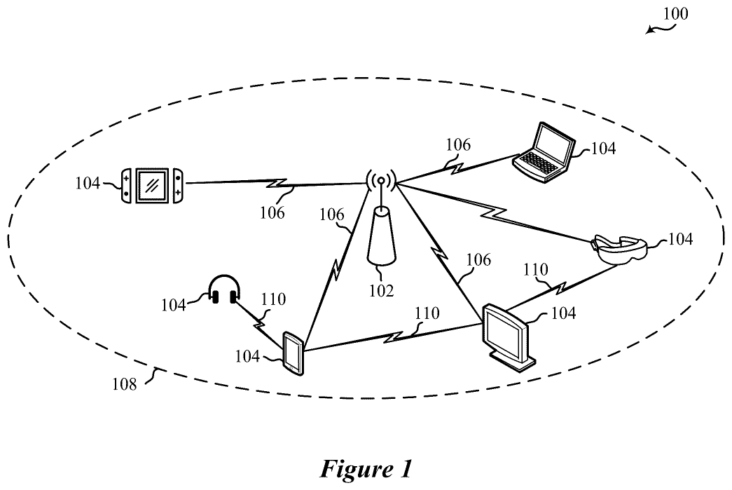

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels. Additionally, or alternatively, the term “subchannel” may refer to a portion of a “channel.” For example, a channel having a channel bandwidth of 20 MHz (e.g., a 20 MHz PPDU) may be composed of (e.g., include, divided into) multiple subchannels (e.g., resource units) each having a bandwidth smaller than the channel bandwidth (e.g., 2.03 MHz, 2.57 MHz).

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a transmission opportunity (TXOP) on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields).

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

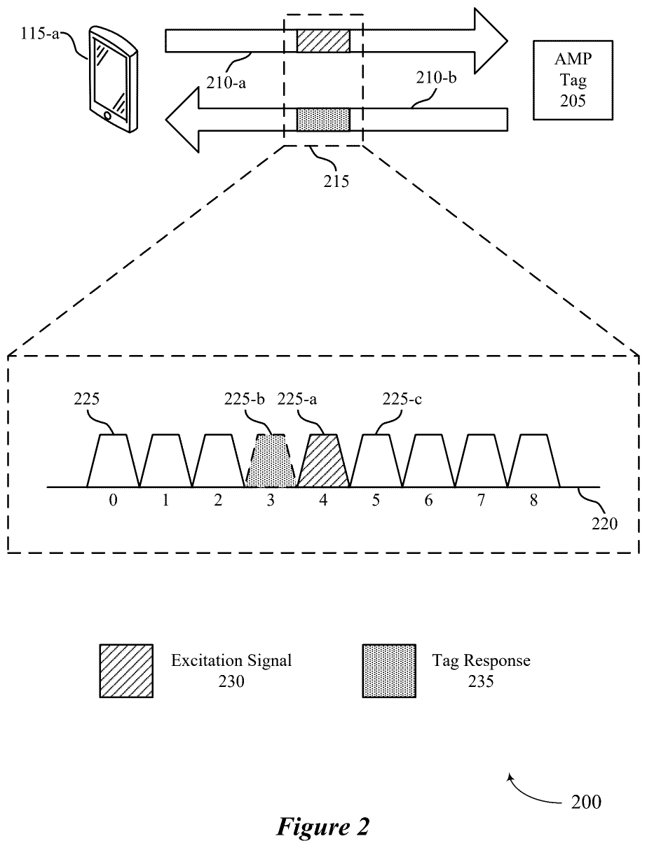

FIG. 2 shows an example of a signaling diagram 200 that supports frequency-translated backscatter modulation for ambient power tags. The signaling diagram 200 may include a UE 115-a in communications with an AMP tag 205, which may be examples of corresponding devices described herein, including with reference to FIG. 1. The AMP tag 205 may be an example of an AMP device. The UE 115-a may communicate with the AMP tag 205 via communication link 210-a and communication link 210-b, which may be examples of uplinks, downlinks, sidelinks, or any combination thereof. For example, the UE 115-a and the AMP tag 205 may communicate signaling via uplink, downlink, sidelink, or any combination thereof.

Communications between the UE 115-a and the AMP tag 205 may occur within a wireless channel 215, which may be associated with a frequency spectrum 220 (e.g., a bandwidth). The wireless channel 215 may include multiple subchannels 225. In the example of FIG. 2, the wireless channel 215 may have a 20 MHz channel bandwidth, and the frequency spectrum 220 of the wireless channel 215 (e.g., a channel bandwidth) may be partitioned (e.g., divided) into nine subchannels 225 with indices 0 through 8, though it should be noted that any channel bandwidth and any number of subchannels may be supported. Additionally, or alternatively, the wireless channel 215 may include (e.g., be configured with) multiple resource units. For example, the wireless channel 215 (e.g., the frequency spectrum 220) may span (e.g., include) a 20 MHz PPDU (e.g., an 802.11ax PPDU) that includes nine resource units. In some examples, some or all of the subchannels 225 may correspond to a respective resource unit. That is, a frequency range associated a subchannel 225 may align with a frequency range associated with a resource unit of the wireless channel 215.

AMP devices may implement energy harvesting techniques to support low-power and low-cost operations. Accordingly, AMP devices may be used in various applications for tagging devices or other objects of interest (e.g., inventory management, self-checkout, etc.). In the example of FIG. 2, the AMP tag 205 may be a close-range AMP device. The AMP tag 205 may communicate with an AMP reader (e.g., a close-range AMP reader). To improve accessibility of communications using an AMP tag 205, it may be beneficial to incorporate the AMP reader into another device (e.g., a smartphone, an AP). In the example of FIG. 2, the UE 115-a may act as (e.g., may include, may integrate) an AMP reader (e.g., AMP reader circuitry) to communicate with the AMP tag 205. For example, the UE 115-a may transmit an excitation signal 230 (e.g., an excitation waveform) to the AMP tag 205. The AMP tag 205 may receive the excitation signal 230 and may transmit a backscattered tag response 235 (e.g., a response waveform) indicating information (e.g., information bits) to the UE 115-a. In some cases, the AMP tag 205, or a component of or coupled with the AMP tag 205 may backscatter the backscattered tag response 235 such that the AMP tag 205 does not draw additional power to transmit the backscattered tag response 235. The UE 115-a may transmit the excitation signal 230 with a high power such that the AMP tag 205 may transmit the backscattered tag response 235.

However, integrating the AMP reader with the UE 115-a may introduce interference at the AMP reader. In some examples, a size of the AMP reader may be reduced to integrate the AMP reader with the UE 115-a, which may increase proximity between transmitting antenna and receiving antenna of the AMP reader. Such an increase in proximity may increase a likelihood of interference at the AMP reader. For example, transmitting the excitation signal 230 with a high-power may overpower (e.g., interfere with) the backscattered tag response 235 and impact the ability of the UE 115-a to decode the information indicated by the backscattered tag response 235. In some implementations, the UE 115-a may include self-interference cancelling architecture (e.g., circuitry) to compensate for interference caused by power leakage from the excitation signal 230. However, to include such architecture, the existing receiver architecture may be modified, which may be costly to implement.

Various aspects of the present disclosure described herein relate to frequency-translated backscatter modulation for AMP tags. In some examples, the UE 115-a may transmit an excitation signal 230 to the AMP tag 205. The excitation signal 230 may be a narrowband waveform such that the UE only loads a portion of the frequency spectrum 220 with the excitation signal 230. The remainder of the frequency spectrum 220 (e.g., one or more remaining portions of the frequency spectrum 220, a remaining 8 subchannels, a remaining 8 resource units) may be unloaded (e.g., empty, nullified). For example, the UE 115-a may transmit the excitation signal 230 in a first subchannel 225-a of the subchannels 225 and may refrain from transmitting additional signaling in the other subchannels 225 excluding the first subchannel 225-a. In some examples, the first subchannel 225-a (e.g., a loaded subchannel) may span a first frequency range (e.g., 2.57 MHz), and the unloaded subchannels 225 may span a second frequency range (e.g., 2.03 MHz). In some cases, the UE 115-a may apply pulse shaping to the excitation signal 230. Separation of the excitation signal 230 and the backscattered tag response 235 in frequency may reduce interference severity and ease interference cancellation at the UE 115-a. In some examples where the subchannels 225 correspond to respective resource units of the wireless channel, the UE 115-a may transmit the excitation signal 230 via a first resource unit. The UE 115-a may transmit the excitation signal 230 across multiple TTIs. For example, the UE 115-a may transmit the excitation signal 230 via multiple slots.

The AMP tag 205 may receive the excitation signal 230 via the first subchannel 225. As described herein, the AMP tag 205 or a component associated with the AMP tag 205 may backscatter the excitation signal 230 to transmit the backscattered tag response 235. However, in the example of FIG. 2, the AMP tag 205 may also apply a frequency translation to the excitation signal 230 such that the AMP tag 205 transmits the backscattered tag response 235 within the one or more empty portions of the frequency spectrum 220. For example, in FIG. 2, the AMP tag 205 may transmit the backscattered tag response 235 by frequency translating the excitation signal 230 from the first subchannel 225-a to a second subchannel 225-b. The second subchannel 225-b may be non-overlapping (e.g., in frequency) with the first subchannel 225-a. Although the second subchannel 225-b is illustrated as a specific subchannel 225 corresponding to subchannel index 3 in the example of FIG. 2, it should be noted that the second subchannel 225-b may be any subchannel 225 other than the first subchannel 225-a.

Additionally, or alternatively, in some examples where the subchannels 225 correspond to respective resource units of the wireless channel, the AMP tag 205 may transmit the backscattered tag response 235 in a second resource unit. The second resource unit may be associated with a different frequency range and a different index than the first resource unit. In some examples, when a UE 115 (e.g., a smartphone) transmits an excitation signal 230 in a first subchannel 225-a (e.g., in a particular RU), the UE 115 may generate some emissions in neighboring subchannels 225 (e.g., one or more subchannels adjacent to the first subchannel 225-a) which may act as noise to the backscattered tag response 235. The noise generated in the neighboring subchannels 225 may decrease as the subchannels 225 become further away (e.g., in frequency) from the first subchannel 225-a as per spectral mask regulations. Considering this, the UE 115 may transmit the excitation signal 230 in the first subchannel 225-a (e.g., RU at index #1) and the AMP tag 205 may frequency translate (e.g., frequency shift) the backscattered tag response 235 by more than one subchannel away from the first subchannel 225-a (e.g., the backscattered tag response 235 may be shifted three or more RUs away (to RU #4 or beyond) to make the backscatter communication link perform better. As such, the techniques discussed herein may apply to other mappings between information bit values and subchannels 225 where the AMP tag 205 may frequency translate (e.g., frequency shift) the backscattered tag response 235 to manage noise caused in other subchannels 225 by transmission of the excitation signal 230 in the first subchannel 225-a.

In some cases where the UE 115-a transmits the excitation signal 230 over multiple TTIs, the AMP tag 205 may receive the excitation waveform via a first set of TTIs and may transmit the backscattered tag response 235 via a second set of TTIs. Each backscattered tag response 235 transmitted in each of the second set of TTIs may indicate a different information bit value or set of information bit values such that the backscattered tag response 235 indicates a sequence of the set of information bits across the second set of TTIs. However, due to clock drift at the AMP tag 205, the first set of TTIs associated with the excitation signal 230 and the second set of TTIs associated with the backscattered tag response 235 may not align in time. That is, the UE 115-a may receive the symbols of the backscattered tag response 235 within a time duration that is associated with the first set of TTIs. In some cases, the time duration may be offset (e.g., in time) from the first set of TTIs. The UE 115-a may prompt the AMP tag 205 to use a clock recovery coding scheme to indicate the offset such that the UE 115-a may receive and decode the backscattered tag response 235.

By transmitting the backscattered tag response 235 in accordance with the applied frequency translation, the backscattered tag response may be isolated (e.g., separated) from the excitation signal 230 in frequency, which may enable the UE 115-a to more reliably receive the backscattered tag response 235, to more accurately decode the information from the backscattered tag response 235, or both. In some cases, the excitation signal 230 may be a pure sinusoidal tone, and the backscattered tag response 235 may be an amplitude modulated signal over the sine tone excitation (e.g., the sinusoidal excitation signal 230). In such cases, the UE 115-a may implement a notch filter to eliminate the sine tone (e.g., filter out a frequency associated with the excitation signal) and isolate the backscattered tag response 235. In some examples, the UE 115-a may receive the backscattered tag response 235 and may implement energy detection procedures to decode the information from the backscattered tag response 235. For example, the UE 115-a may perform energy detection on the subchannels 225 (e.g., some or all of the subchannels 225) to determine one or more information bit values indicated by the backscattered tag response 235.

In the example of FIG. 2, the first subchannel 225-a may be a central subchannel 225 of the frequency spectrum 220. For example, the first subchannel 225-a may correspond to (e.g., include) a center frequency of the excitation signal 230. However, in some other examples not illustrated herein, the first subchannel 225-a may not be a central subchannel 225 of the frequency spectrum 220. For example, transmitting the excitation signal 230 via the first subchannel 225-a may generate noise that interferes with the one or more empty portions of the frequency spectrum 220. Specifically, subchannels 225 adjacent to the first subchannel 225-a in frequency may suffer noise interference. Accordingly, to reduce the impact of noise interference on the empty portions of the frequency spectrum 220, the center frequency of the excitation signal 230 may be offset from the first subchannel 225-a. Such an offset may support a larger empty portion of the frequency spectrum 220 (e.g., additional subchannels 225 included in the empty portion), which may allow for greater flexibility at the AMP tag 205 for transmitting the backscattered tag response 235 when considering noise interference generated by transmitting the excitation signal 230.

The AMP tag 205 may modulate data with the backscattered tag response 235. In some examples, the AMP tag 205 may modulate the data on top of (e.g., with) the excitation signal 230 in accordance with one or more techniques described herein such that the backscattered tag response 235 indicates the data (e.g., information bit values). In some examples, the AMP tag 205 may modulate the data using FSK modulation. For example, as described herein, the AMP tag 205 may apply a frequency translation to the excitation signal 230 to transmit the backscattered tag response 235 indicating a value for an information bit (e.g., one information bit). In some cases, an increase in the frequency of the backscattered tag response 235 may correspond to a first bit value (e.g., a 0), and a decrease in the frequency of the backscattered tag response 235 may correspond to a second bit value (e.g., a 1). For example, the AMP tag 205 may transmit (e.g., output) the backscattered tag response 235 via the second subchannel 225-b to indicate the first bit value (e.g., 0) and may transmit the backscattered tag response 235 via a third subchannel 225-c to indicate the second bit value (e.g., 1). Alternatively, an increase in the frequency of the backscattered tag response 235 may correspond to the second bit value (e.g., a 1), and a decrease in the frequency of the backscattered tag response 235 may correspond to the first bit value (e.g., a 0). For example, the AMP tag 205 may transmit the backscattered tag response 235 via the second subchannel 225-b to indicate the second bit value (e.g., 1) and may transmit the backscattered tag response 235 via the third subchannel 225-c to indicate the second bit value (e.g., 0). In the example of FIG. 2, implementation of an FSK modulation scheme may support a data rate of 62.5 kbps for the AMP tag 205.

The AMP tag 205 may transmit the backscattered tag response 235 via the second subchannel 225-b, where the second subchannel 225-b is frequency shifted from the first subchannel 225-a by the applied frequency translation. In the example of FIG. 2, the second subchannel 225-b may be adjacent to the first subchannel 225-a in frequency. For example, the first subchannel 225-a and the second subchannel 225-b may be continuous in frequency. In some other examples, to account for noise interference generated by the excitation signal 230, the second subchannel 225-b may be separated from the first subchannel 225-a (e.g., non-continuous) in frequency. Additionally, or alternatively, in some examples where the subchannels 225 correspond to respective resource units of the wireless channel, the AMP tag 205 may transmit the backscattered tag response 235 in a second resource unit having a frequency range and a resource unit index different from the first resource unit.

The UE 115-a may receive the backscattered tag response 235 and may perform energy detection on the subchannels 225 of wireless channel 215. The UE 115-a may compare calculated energies for each subchannel to decode information from the backscattered tag response 235. For example, in FIG. 2, the UE 115-a may measure an energy of the second subchannel 225-b, as well as the third subchannel 225-c. In some examples, the second subchannel 225-b may have a subchannel index of 3, and the third subchannel 225-c may have a subchannel index of 5. The UE 115-a may compare the energy of the second subchannel 225-b to the energy of the third subchannel 225-c. If the UE 115-a determines that the energy of the second subchannel 225-b (e.g., subchannel index 3) is greater than the energy of the third subchannel 225-c (e.g., subchannel index 5), the UE 115-a may decode a first bit value (e.g., a 0) from the backscattered tag response 235. Alternatively, if the UE 115-a determines that the energy of the second subchannel 225-b (e.g., subchannel index 3) is less than the energy of the third subchannel 225-c (e.g., subchannel index 5), the UE 115-a may decode a second bit value (e.g., a 1) from the backscattered tag response 235. To calculate the energy of a subchannel 225, the UE 115-a may measure, square (e.g., take an absolute square of), and sum (e.g., perform a summation of) subcarrier amplitudes of the subchannel 225.

A result of the energy detection (e.g., the comparison) may indicate the frequency translation applied to the excitation signal 230, which the UE 115-a may use to decode the information from the backscattered tag response 235. In some examples, the third subchannel 225-c may be associated with a frequency translation from the first subchannel 225-a that is opposite from the second subchannel 225-b. That is, if the second subchannel 225-b indicates an increase in frequency from the first subchannel 225-a, the third subchannel 225-c may indicate a decrease in frequency from the first subchannel 225-a. Described visually with respect to FIG. 2, if the second subchannel 225-b is located to the left of the first subchannel 225-a, the third subchannel 225-c may be located to the right of the first subchannel 225-a. In the example of FIG. 2, the second subchannel 225-b and the third subchannel 225-c may both be adjacent to the first subchannel 225-a in frequency. However, in some other examples, at least the second subchannel 225-b may be separated from the first subchannel 225-a in frequency to account for noise interference generated by the excitation signal 230.

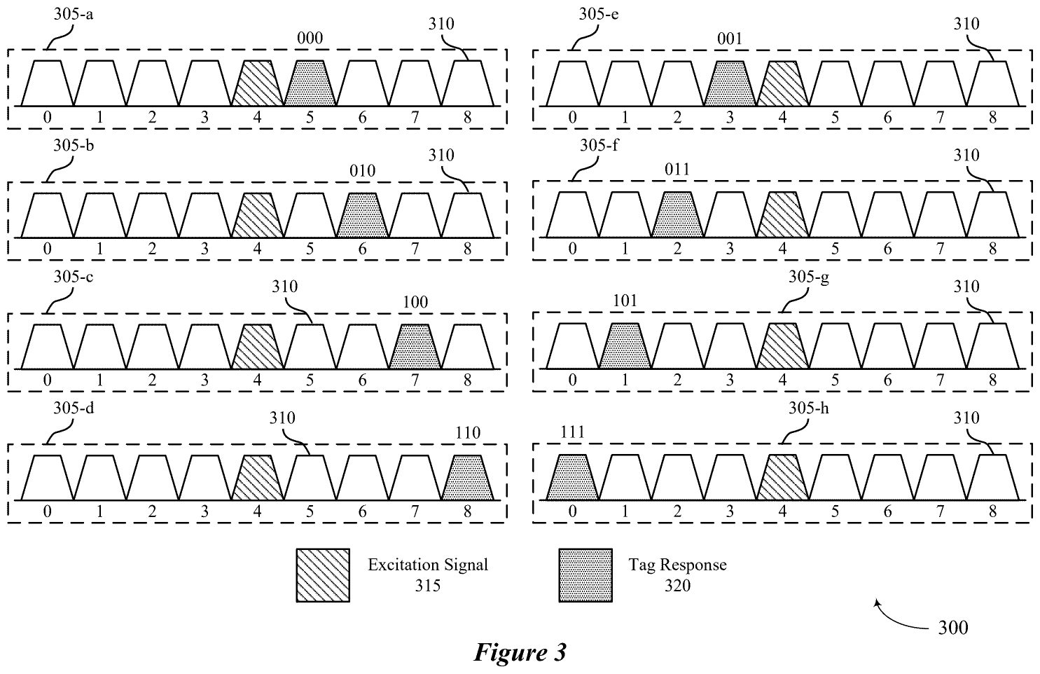

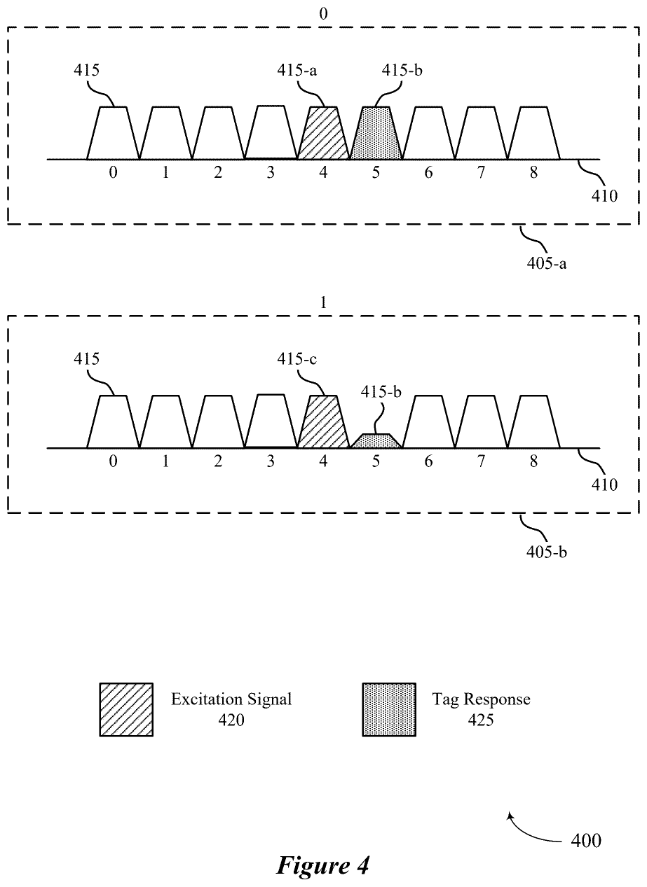

In some other examples, the backscattered tag response 235 may indicate multiple information bit values in accordance with a magnitude of the frequency translation applied to the excitation signal 230 and a bit mapping. Additional examples of such a backscattered tag response 235 and mapping, as well as examples of decoding such a backscattered tag response 235, are explained in further detail herein with respect to FIG. 3. Additionally, or alternatively, the AMP tag 205 may modulate the data using an OOK modulation scheme. Additional examples of such a modulation scheme, as well as examples of decoding such a backscattered tag response 235, are explained in further detail herein with respect to FIG. 4.

Implementation of frequency-based modulation for AMP tag operations may be associated with various advantages. If implemented by the AMP tag 205, frequency-based modulation schemes may reduce power consumption at the tag. In some implementations, the AMP tag 205 may shift the excitation signal 230 over a greater frequency range, such as to a different wireless channel 215 (e.g., over 25 MHz), which may consume significant power at the AMP tag (e.g., 28 μW). However, shifting the backscattered tag response 235 to a different subchannel 225 within a frequency spectrum 220 (e.g., over 2.5 MHz) may reduce the magnitude of the frequency translation and may proportionally reduce the power consumed by the AMP tag 205 (e.g., 2.8 μW) to perform the frequency translation. If implemented by the UE 115-a, frequency-based modulation schemes may support AMP reader operations at the UE 115-a without modifying existing receiver architecture at the UE 115-a. Reusing the existing front-end receiver architecture may reduce complexity and costs of integrating an AMP reader with the UE 115-a. In some examples, AMP reader operations may be implemented at the UE 115-a as an algorithm at a processor (e.g., a digital signal processor (DSP)).

FIG. 3 shows an example of a mapping scheme 300 that supports frequency-translated backscatter modulation for ambient power tags. The mapping scheme 300 may be implemented by a UE and an AMP tag, which may be examples of corresponding devices described herein, including with reference to FIGS. 1 and 2. In some examples, the mapping scheme 300 may illustrate a bit mapping corresponding to multiple frequency spectra 305 (e.g., a frequency spectrum 305-a, a frequency spectrum 305-b, a frequency spectrum 305-c, a frequency spectrum 305-d, a frequency spectrum 305-e, a frequency spectrum 305-f, a frequency spectrum 305-g, a frequency spectrum 305-h), which may be examples of corresponding structures described herein, including with reference to FIG. 2. For example, each of the frequency spectra 305 (e.g., channels, channel bandwidths) may include (e.g., be partitioned into) multiple subchannels 310. In the example of FIG. 3, each frequency spectrum 305 may be divided into nine subchannels 310 with indices 0 through 8. Each frequency spectrum 305 may further illustrate an excitation signal 315 and a tag response 320 communicated within the frequency spectrum 305. Each excitation signal 315 and tag response 320 may be communicated via different subchannels 310 of a respective frequency spectrum 305.

As described herein with reference to FIG. 2, the UE may transmit the excitation signal 315 via a central subchannel 310 of the frequency spectrum 305. In the example of FIG. 3, each frequency spectrum 305 may illustrate an excitation signal 315 that is communicated via a central subchannel 310. The central subchannel 310 may have a subchannel index of 4. As additionally described herein with reference to FIG. 2, the AMP tag may transmit (e.g., output) the tag response 320 via any subchannel 310 other than the central subchannel 310 that includes the excitation signal 315 in accordance with a frequency translation, where each subchannel 310 other than the central subchannel 310 may be associated with one or both of a different frequency translation magnitude and a different direction (e.g., increase, decrease). For example, the AMP tag may receive the excitation signal 315 via the central subchannel 310 with subchannel index 4. The AMP tag may apply a frequency translation to the excitation signal 315 to transmit a tag response 320. In an example, the AMP tag may transmit the tag response 320 via a subchannel 310 with index 5 in accordance with a first frequency translation to indicate a bit value of 000 (e.g., three bits). In another example, the AMP tag may transmit the tag response 320 via a subchannel 310 with index 2 in accordance with a second frequency translation to indicate a bit value of 011.

In the example of FIG. 3, the AMP tag may modulate data with the tag response 320 in accordance with an FSK modulation scheme and the mapping scheme 300. The mapping scheme 300 may illustrate examples of the frequency spectra 305 including tag responses 320 communicated via each of the subchannels 310 other than the central subchannel 310 of the frequency spectra 305. A UE may use the mapping scheme 300 to decode information from a received tag response 320. In some examples, each frequency spectrum 305 may indicate different information based on which subchannel 310 includes the tag response 320. That is, each subchannel 310 other than the central subchannel 310 may be associated with (e.g., map to) a different value for a number of information bits in accordance with the mapping scheme 300. The number of information bits may be based on the number of subchannels 310 other than the central subchannel 310 of the frequency spectra 305. For example, in FIG. 3, the mapping scheme 300 may indicate three binary information bit values per tag symbol (e.g., per symbol of the tag response 320) based on each frequency spectrum 305 including eight subchannels 310 other than the central subchannel 310.

The UE may decode the information bit values from the received tag response 320 in accordance with the mapping scheme 300 and in accordance with an energy detection operation. As described herein, the UE may calculate an energy of each subchannel 310 other than the central subchannel 310 using energy detection. The UE may compare the calculated subchannel energies to determine (e.g., identify) a subchannel 310 with a highest calculated subchannel energy. The UE may determine, based on the comparison, that the tag response 320 was received via the subchannel 310 with the highest calculated subchannel energy, and may decode information bit values (e.g., three bit values) from the tag response 320 in accordance with the mapping scheme 300.

The mapping scheme 300 may provide example bit value mappings for the subchannels 310. For example, if the UE determines that the highest calculated subchannel energy corresponds to a subchannel 310 with index 5, the UE may decode a value of 000 from the tag response 320. If the UE determines that the highest calculated subchannel energy corresponds to a subchannel 310 with index 6, the UE may decode a value of 010 from the tag response 320. If the UE determines that the highest calculated subchannel energy corresponds to a subchannel 310 with index 7, the UE may decode a value of 100 from the tag response 320. If the UE determines that the highest calculated subchannel energy corresponds to a subchannel 310 with index 8, the UE may decode a value of 110 from the tag response 320.

Similarly, if the UE determines that the highest calculated subchannel energy corresponds to a subchannel 310 with index 3, the UE may decode a value of 001 from the tag response 320. If the UE determines that the highest calculated subchannel energy corresponds to a subchannel 310 with index 2, the UE may decode a value of 011 from the tag response 320. If the UE determines that the highest calculated subchannel energy corresponds to a subchannel 310 with index 1, the UE may decode a value of 101 from the tag response 320. If the UE determines that the highest calculated subchannel energy corresponds to a subchannel 310 with index 0, the UE may decode a value of 111 from the tag response 320. It should be noted that the bit value mapping examples provided by the mapping scheme 300 are not an exhaustive list of bit value mappings. That is, in some other examples not illustrated herein, each frequency spectrum 305 may map to a bit value different from what is provided in FIG. 3.

Implementation of the mapping scheme 300 for frequency-based modulation for AMP tag operations may be associated with various advantages. For example, implementation of the mapping scheme 300 by the AMP tag, the UE, or both, may increase a data rate associated with the AMP tag. In the example of FIG. 3, implementation of an FSK modulation scheme with the mapping scheme 300 may support an increased data rate of 187.5 kbps for the AMP tag 205. In some cases, the increased data rate may be based on the number of information bits indicated by each frequency spectrum 305 of the mapping scheme 300. In the example of FIG. 3, because the frequency spectra 305 indicate three information bits, the data rate may be proportionally three times higher than the frequency spectrum 220 described with reference to FIG. 2 that indicates one information bit.

FIG. 4 shows an example of an amplitude modulation scheme 400 that supports frequency-translated backscatter modulation for ambient power tags. The amplitude modulation scheme 400 may be implemented by a UE and an AMP tag, which may be examples of corresponding devices described herein, including with reference to FIGS. 1 and 2. The amplitude modulation scheme 400 may illustrate a first channel 405-a and a second channel 405-b. Each channel 405 may include (e.g., span, be defined over) a frequency spectrum 410, each of which may be examples of corresponding structures described herein, including with reference to FIG. 2. For example, each channel 405 may be divided into multiple subchannels 415. In the example of FIG. 4, each channel 405 may be divided into nine subchannels 415 with indices 0 through 8. Each channel 405 may further illustrate an excitation signal 420 and a tag response 425 communicated within a respective frequency spectrum 410. In the example of FIG. 4, the excitation signals 420 and tag responses 425 communicated via the first channel 405-a may be communicated via a same respective subchannel 415 of a respective frequency spectrum 410 of a corresponding channel 405 (e.g., the second channel 405-b).

As described herein with reference to FIG. 2, the UE may transmit the excitation signal 420 via a first subchannel 415 of the frequency spectrum 410. In the example of FIG. 4, the first channel 405-a may illustrate an excitation signal 420 that is communicated via a respective first subchannel 415-a, and the second channel 405-b may illustrate an excitation signal 420 that is communicated via a respective first subchannel 415-c. In some examples, both the first subchannel 415-a and the first subchannel 415-c may be central in the frequency spectrum 410 as described herein with reference to FIG. 2. For example, both the first subchannel 415-a and the first subchannel 415-c may have a subchannel index of 4.

In the example of FIG. 4, the AMP tag may modulate data with the tag response 425 in accordance with an OOK modulation scheme. In such examples, the AMP tag may both apply a frequency translation to the excitation signal 420 and may adjust an amplitude (e.g., energy level) of the tag response 425 to indicate a value for an information bit (e.g., one information bit) via the tag response. As described herein with reference to FIG. 2, the AMP tag may transmit the tag response 425 via a second subchannel 415-b of the frequency spectrum 410 that differs from (e.g., does not overlap) the first subchannel 415-a or the first subchannel 415-c in accordance with the frequency translation. In the example of FIG. 4, the first channel 405-a may include a tag response 425 that is communicated via a respective second subchannel 415-b, and the second channel 405-b may include a tag response 425 that is communicated via a respective second subchannel 415-b. The AMP device and the UE may communicate signaling to agree on a magnitude of the frequency translation and a direction of the frequency translation such that the UE performs energy detection on the second subchannel. For example, the AMP device and the UE may agree to communicate the tag response via a second subchannel 415-b. In the example of FIG. 4, the AMP device and the UE may determine the frequency translation magnitude and direction prior to communicating the tag response 425.

In some examples, when the UE (e.g., a smartphone) transmits the excitation signal 420 in the first subchannel 415-a or the first subchannel 415-c (e.g., in a particular RU), the UE may generate some emissions in neighboring subchannels 415 (e.g., one or more subchannels adjacent to the first subchannel 415-a or the first subchannel 415-c) which may act as noise to the tag response 425. The noise generated in the neighboring subchannels 415 may decrease as the subchannels 415 become further away (e.g., in frequency) from the first subchannel 415-a or the first subchannel 415-c as per spectral mask regulations. Considering this, the UE may transmit the excitation signal 420 in the first subchannel 415-a or the first subchannel 415-c (e.g., RU at index #1) and the AMP tag may frequency translate (e.g., frequency shift) the tag response 425 by more than one subchannel away from the first subchannel 415-a or the first subchannel 415-c (e.g., the tag response 425 may be shifted three or more RUs away (to RU #4 or beyond) to make the backscatter communication link perform better. As such, the techniques discussed herein may apply to other mappings between information bit values and subchannels 415 where the AMP tag may frequency translate (e.g., frequency shift) the tag response 425 to manage noise caused in other subchannels 415 by transmission of the excitation signal 420 in the first subchannel 415-a or the first subchannel 415-c.

In some examples, the AMP tag may modulate the data with the tag response 425 by adjusting an energy level (e.g., an amplitude) of the tag response 425 in accordance with the OOK modulation scheme. Different values for the energy level of the tag response 425 may indicate different information bit values. For example, a first energy level may correspond to a first information bit value (e.g., a 0), and a second energy level may correspond to a second information bit value (e.g., a 1). In such examples, the second energy level may be lower than the first energy level, but in some other examples the second energy level may be higher than the first energy level. In the example of FIG. 4, the first channel 405-a may indicate the first information bit value (e.g., 0) based on the energy of the tag response communicated via the second subchannel 415-b. Similarly, the second channel 405-b may indicate the second information bit value (e.g., 1) based on the energy of the tag response 425 communicated via the second subchannel 415-b. The amplitude (e.g., energy) of the tag response 425 may vary between instances of the tag response 425 (e.g., between the first channel 405-a and the second channel 405-b) to indicate different bit values.

A UE may decode the information bit values from the received tag response 425 in accordance with the agreed frequency translation and in accordance with an energy detection operation. The UE may calculate an energy of the second subchannel 415-b as described herein. For example, the UE may square (e.g., take an absolute square of) and sum subcarrier amplitudes that are included in the second subchannel 415-b to calculate the energy of the second subchannel 415-b. The UE may compare the energy to a threshold energy level to determine (e.g., decode) the information bit value indicated by the tag response 425. For example, the UE may determine that the tag response 425 communicated in the first channel 405-a indicates the first information bit value (e.g., 0) based on determining that the energy of the second subchannel 415-b satisfies (e.g., is greater than) the threshold energy level. Conversely, the UE may determine that the tag response 425 communicated in the second channel 405-b indicates the second information bit value (e.g., 1) based on determining that the energy of the second subchannel 415-b does not satisfy (e.g., is less than) the threshold energy level. The UE may determine the threshold energy level based on signaling from the AMP tag. For example, the AMP tag may transmit a training field (e.g., a training sequence) to the UE prior to communicating the tag response 425 that indicates the threshold energy level.

Implementation of the amplitude modulation scheme 400 for frequency-based modulation for AMP tag operations may be associated with various advantages. For example, implementation of the amplitude modulation scheme 400 by the UE may reduce decoding complexity and decoding power consumption at the UE. For example, the UE may perform fewer energy detection operations to decode an OOK-modulated tag response 425 than to decode an FSK-modulated tag response 425 as a result of coordinating the magnitude of the frequency translation applied to the excitation signal 420 with the AMP tag.

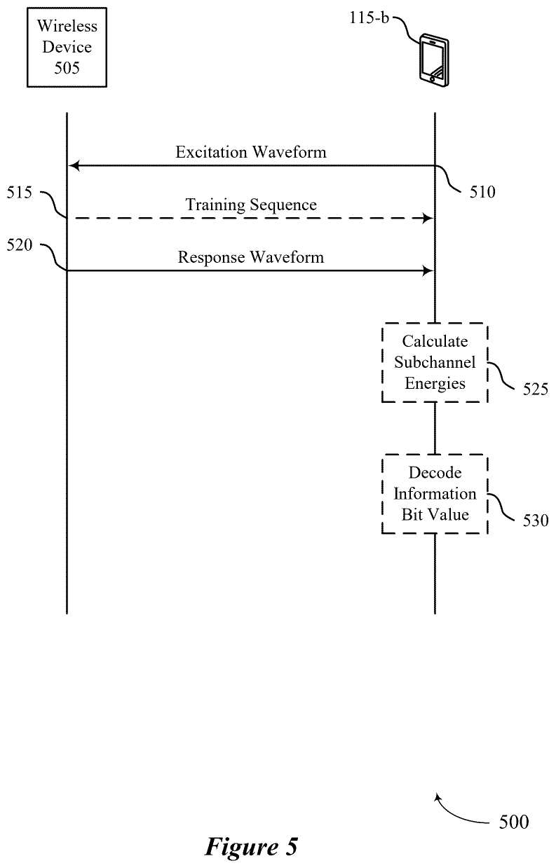

FIG. 5 shows an example of a process flow 500 that supports frequency-translated backscatter modulation for ambient power tags. The process flow 500 may implement or be implemented by aspects of the wireless communications network 100, the signaling diagram 200, the mapping scheme 300, the amplitude modulation scheme 400, or any combination thereof, as described with reference to FIGS. 1-4. For example, the process flow 500 may illustrate actions performed by a wireless device 505 and a UE 115-b. In some examples, the wireless device 505 may be an example of an AMP tag as described with reference to FIGS. 2-4. In the following description of the process flow 500, the operations between the wireless device 505 and the UE 115-b may be performed in a different order than the example shown, or the operations between the wireless device 505 and the UE 115-b may be performed in different orders at different times. Some operations may also be omitted from the process flow 500, and other operations may be added to the process flow 500.

At 510, the wireless device 505 may receive an excitation waveform, transmitted from the UE 115-b, via a first subchannel of a plurality of subchannels of a channel bandwidth. The excitation waveform may be received via the first subchannel that is a single subchannel of the plurality of subchannels of the channel bandwidth. In some examples, each subchannel of the plurality of subchannels other than the first subchannel may be associated with one or more information bit values. For example, each subchannel of the plurality of subchannels other than the first subchannel may correspond to a value of the one or more information bits in accordance with a bit mapping. Additionally, or alternatively, each subchannel of the plurality of subchannels may correspond to a different resource unit of a plurality of resource units included within the channel bandwidth. In some cases, the wireless device 505 may receive the excitation waveform via the first subchannel over a plurality of TTIs.

At 515, the wireless device 505 may transmit, and the UE 115-b may receive, a training sequence associated with an amplitude of the backscattered response waveform. In some examples, an amplitude threshold associated with a first bit value of the one or more information bits may be based on the training sequence.

At 520, the wireless device 505 may output, and the UE 115-b may receive, a backscattered response waveform via a second subchannel of the plurality of subchannels of the channel bandwidth based on the excitation waveform. In some examples, the backscattered response waveform may be based on a frequency translation of signal energy of the excitation waveform from the first subchannel to the second subchannel. In such examples, the frequency translation from the first subchannel to the second subchannel may indicate the one or more information bits (e.g., bit values). For example, the frequency translation from the first subchannel to the second subchannel may be an increase in frequency that is associated with a first value for an information bit of the one or more information bits or a decrease in frequency that is associated with a second value for an information bit of the one or more information bits. The backscattered response waveform may be backscattered in the second subchannel that is any subchannel of the plurality of subchannels other than the first subchannel. In some examples, the wireless device 505 may transmit the training sequence at 515 before outputting the backscattered response waveform.

The wireless device 505 may output the backscattered response waveform at a first signal energy level that is one of a plurality of different signal energy levels. In such cases, each signal energy level of the plurality of different signal energy levels may correspond to a different value for an information bit of the one or more information bits. Additionally, or alternatively, if the wireless device 505 receives the excitation waveform via the first subchannel over the plurality of TTIs, the wireless device 505 may output the backscattered response waveform into at least one subchannel of the plurality of subchannels other than the first subchannel during a time duration associated with the plurality of TTIs to indicate a sequence of the one or more information bits. The time duration may be offset from the plurality of TTIs in accordance with a clock drift parameter of the wireless device 505.

At 525, the UE 115-b may calculate an energy of the second subchannel and an energy of the one or more other subchannels based on a summation of one or more squares (e.g., absolute squares) of one or more respective subcarrier amplitudes of the second subchannel and the one or more other subchannels. In some examples, the UE 115-b may determine that the second subchannel is associated with a highest subchannel energy of the plurality of subchannels other than the first subchannel.

At 530, the UE 115-b may decode a value of an information bit of the one or more information bits from the backscattered response waveform based on a comparison of energy detected for the second subchannel relative to energy detected for one or more other subchannels of the plurality of subchannels other than the first subchannel. In some examples, the UE 115-b may decode the value of the information bit of the one or more information bits from the backscattered response waveform based on a comparison of an amplitude of the backscattered response waveform received via the second subchannel to a threshold. In such examples, the threshold may be based on the training sequence received from the wireless device 505.

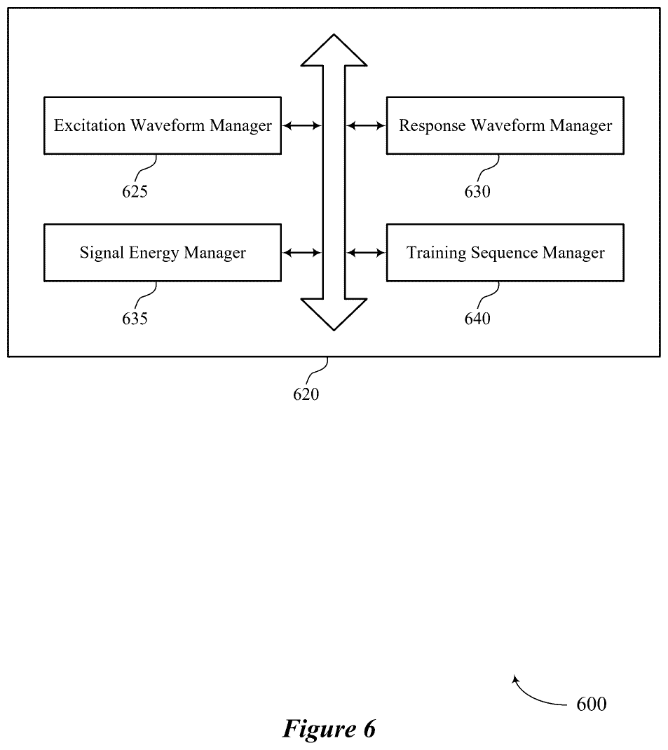

FIG. 6 shows a block diagram 600 of a wireless device 620 that supports frequency-translated backscatter modulation for ambient power tags in accordance with one or more aspects of the present disclosure. The wireless device 620 may be an example of aspects of a wireless device as described with reference to FIGS. 1 through 5. The wireless device 620, or various components thereof, may be an example of means for performing various aspects of frequency-translated backscatter modulation for AMP tags as described herein. For example, the wireless device 620 may include an excitation waveform manager 625, a response waveform manager 630, a signal energy manager 635, a training sequence manager 640, or any combination thereof. Each of these components, or components or subcomponents thereof (e.g., one or more processors, one or more memories), may communicate, directly or indirectly, with one another (e.g., via one or more buses).

The wireless device 620 may support wireless communications in accordance with examples as disclosed herein. The excitation waveform manager 625 is configurable or configured to receive an excitation waveform via a first subchannel of a set of multiple subchannels of a channel bandwidth. The response waveform manager 630 is configurable or configured to output a backscattered response waveform via a second subchannel of the set of multiple subchannels of the channel bandwidth based on the excitation waveform, where the backscattered response waveform is based on a frequency translation of signal energy of the excitation waveform from the first subchannel to the second subchannel, and where the frequency translation from the first subchannel to the second subchannel indicates one or more information bits.

In some examples, each subchannel of the set of multiple subchannels other than the first subchannel is associated with one or more information bit values.

In some examples, the frequency translation from the first subchannel to the second subchannel is an increase in frequency that is associated with a first value for an information bit of the one or more information bits or a decrease in frequency that is associated with a second value for an information bit of the one or more information bits.

In some examples, each subchannel of the set of multiple subchannels corresponds to a different resource unit of a set of multiple resource units included within the channel bandwidth.

In some examples, to support outputting the backscattered response waveform, the signal energy manager 635 is configurable or configured to output the backscattered response waveform at a first signal energy level that is one of a set of multiple different signal energy levels, where each signal energy level of the set of multiple different signal energy levels corresponds to a different value for an information bit of the one or more information bits.

In some examples, the excitation waveform manager 625 is configurable or configured to receive the excitation waveform via the first subchannel over a set of multiple TTIs. In some examples, the response waveform manager 630 is configurable or configured to output the backscattered response waveform into at least one subchannel of the set of multiple subchannels other than the first subchannel during a time duration associated with the set of multiple TTIs to indicate a sequence of the one or more information bits.

In some examples, the training sequence manager 640 is configurable or configured to transmit a training sequence associated with an amplitude of the backscattered response waveform, where an amplitude threshold associated with a first bit value of the one or more information bits is based on the training sequence.

In some examples, the excitation waveform is received via the first subchannel that is a single subchannel of the set of multiple subchannels of the channel bandwidth and the backscattered response waveform is backscattered in the second subchannel that is any subchannel of the set of multiple subchannels other than the first subchannel.

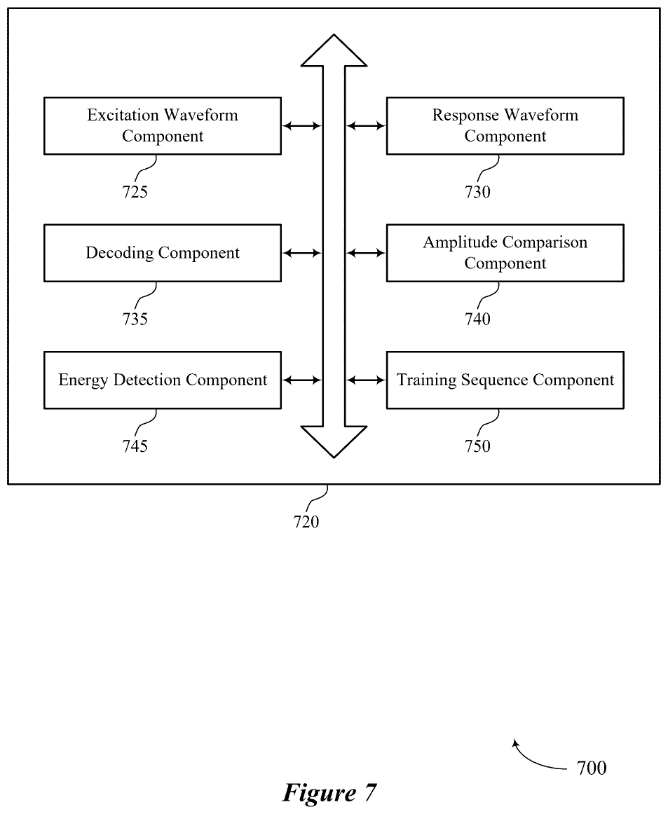

FIG. 7 shows a block diagram 700 of a UE 720 that supports frequency-translated backscatter modulation for ambient power tags in accordance with one or more aspects of the present disclosure. The UE 720 may be an example of aspects of a UE as described with reference to FIGS. 1 through 5. The UE 720, or various components thereof, may be an example of means for performing various aspects of frequency-translated backscatter modulation for AMP tags as described herein. For example, the UE 720 may include an excitation waveform component 725, a response waveform component 730, a decoding component 735, an amplitude comparison component 740, an energy detection component 745, a training sequence component 750, or any combination thereof. Each of these components, or components or subcomponents thereof (e.g., one or more processors, one or more memories), may communicate, directly or indirectly, with one another (e.g., via one or more buses).

The UE 720 may support wireless communications in accordance with examples as disclosed herein. The excitation waveform component 725 is configurable or configured to transmit an excitation waveform via a first subchannel of a set of multiple subchannels of a channel bandwidth. The response waveform component 730 is configurable or configured to receive a backscattered response waveform via a second subchannel of the set of multiple subchannels of the channel bandwidth, where the backscattered response waveform is based on a frequency translation of signal energy of the excitation waveform from the first subchannel to the second subchannel, and where the frequency translation from the first subchannel to the second subchannel indicates one or more information bits.

In some examples, each subchannel of the set of multiple subchannels other than the first subchannel is associated with one or more information bit values.

In some examples, the frequency translation from the first subchannel to the second subchannel is an increase in frequency that is associated with a first value for an information bit of the one or more information bits or a decrease in frequency that is associated with a second value for an information bit of the one or more information bits.

In some examples, each subchannel of the set of multiple subchannels corresponds to a different resource unit of a set of multiple resource units included within the channel bandwidth.

In some examples, the excitation waveform component 725 is configurable or configured to transmit the excitation waveform via the first subchannel over a set of multiple TTIs. In some examples, the response waveform component 730 is configurable or configured to receive the backscattered response waveform via at least one subchannel of the set of multiple subchannels other than the first subchannel during a time duration associated with the set of multiple TTIs to indicate a sequence of the one or more information bits.

In some examples, the decoding component 735 is configurable or configured to decode a value of an information bit of the one or more information bits from the backscattered response waveform based on a comparison of energy detected for the second subchannel relative to energy detected for one or more other subchannels of the set of multiple subchannels other than the first subchannel.

In some examples, the energy detection component 745 is configurable or configured to calculate an energy of the second subchannel and an energy of the one or more other subchannels based on a summation of one or more squares of one or more respective subcarrier amplitudes of the second subchannel and the one or more other subchannels.

In some examples, each subchannel of the set of multiple subchannels other than the first subchannel corresponds to a value of the one or more information bits in accordance with a bit mapping. In some examples, the second subchannel is associated with a highest subchannel energy of the set of multiple subchannels other than the first subchannel.

In some examples, the amplitude comparison component 740 is configurable or configured to decode a value of an information bit of the one or more information bits from the backscattered response waveform based on a comparison of an amplitude of the backscattered response waveform received via the second subchannel to a threshold.

In some examples, the training sequence component 750 is configurable or configured to receive a training sequence, where the threshold is based on the training sequence.

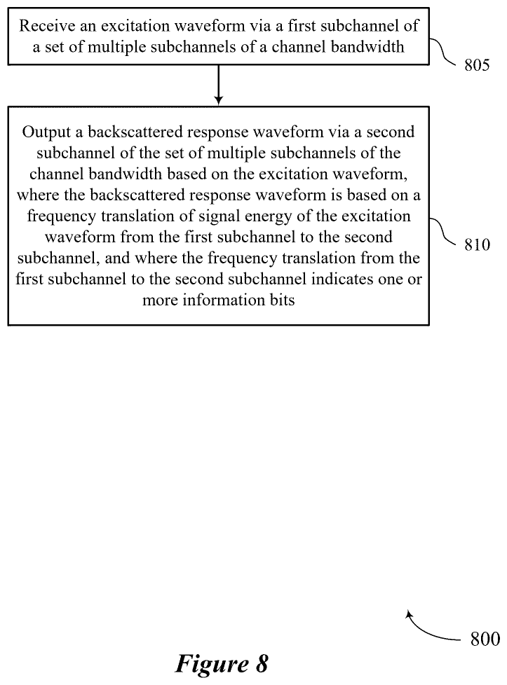

FIG. 8 shows a flowchart illustrating a method 800 that supports frequency-translated backscatter modulation for ambient power tags in accordance with one or more aspects of the present disclosure. The operations of the method 800 may be implemented by a wireless device or its components as described herein. For example, the operations of the method 800 may be performed by a wireless device as described with reference to FIGS. 1 through 6. In some examples, a wireless device may execute a set of instructions to control the functional elements of the wireless device to perform the described functions. Additionally, or alternatively, the wireless device may perform aspects of the described functions using special-purpose hardware.

At 805, the method may include receiving an excitation waveform via a first subchannel of a set of multiple subchannels of a channel bandwidth. The operations of 805 may be performed in accordance with examples as disclosed herein, such as the reception of an excitation signal 230 of FIG. 2, the reception of an excitation signal 315 of FIG. 3, the reception of an excitation signal 420 of FIG. 4, or any combination thereof. The excitation waveform may include information similar to that described with respect to, and illustrated in, FIGS. 2 through 4. In some examples, aspects of the operations of 805 may be performed by an excitation waveform manager 625 as described with reference to FIG. 6.

At 810, the method may include outputting a backscattered response waveform via a second subchannel of the set of multiple subchannels of the channel bandwidth based on the excitation waveform, where the backscattered response waveform is based on a frequency translation of signal energy of the excitation waveform from the first subchannel to the second subchannel, and where the frequency translation from the first subchannel to the second subchannel indicates one or more information bits. The operations of 810 may be performed in accordance with examples as disclosed herein, such as the outputting of a backscattered tag response 235 of FIG. 2, the outputting of a tag response 320 of FIG. 3, the outputting of a tag response 425 of FIG. 4, or any combination thereof. The backscattered response waveform may include information similar to that described with respect to, and illustrated in, FIGS. 2 through 4. In some examples, aspects of the operations of 810 may be performed by a response waveform manager 630 as described with reference to FIG. 6.

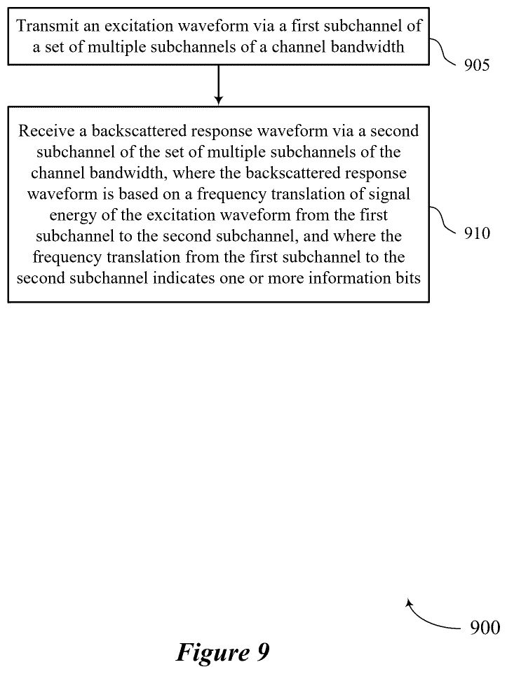

FIG. 9 shows a flowchart illustrating a method 900 that supports frequency-translated backscatter modulation for ambient power tags in accordance with one or more aspects of the present disclosure. The operations of the method 900 may be implemented by a UE or its components as described herein. For example, the operations of the method 900 may be performed by a UE 115 as described with reference to FIGS. 1 through 5 and 7. In some examples, a UE may execute a set of instructions to control the functional elements of the UE to perform the described functions. Additionally, or alternatively, the UE may perform aspects of the described functions using special-purpose hardware.

At 905, the method may include transmitting an excitation waveform via a first subchannel of a set of multiple subchannels of a channel bandwidth. The operations of 905 may be performed in accordance with examples as disclosed herein, such as the transmission of an excitation signal 230 of FIG. 2, the transmission of an excitation signal 315 of FIG. 3, the transmission of an excitation signal 420 of FIG. 4, or any combination thereof. The excitation waveform may include information similar to that described with respect to, and illustrated in, FIGS. 2 through 4. In some examples, aspects of the operations of 905 may be performed by an excitation waveform component 725 as described with reference to FIG. 7.

At 910, the method may include receiving a backscattered response waveform via a second subchannel of the set of multiple subchannels of the channel bandwidth, where the backscattered response waveform is based on a frequency translation of signal energy of the excitation waveform from the first subchannel to the second subchannel, and where the frequency translation from the first subchannel to the second subchannel indicates one or more information bits. The operations of 910 may be performed in accordance with examples as disclosed herein, such as the reception of a backscattered tag response 235 of FIG. 2, the reception of a tag response 320 of FIG. 3, the reception of a tag response 425 of FIG. 4, or any combination thereof. The backscattered response waveform may include information similar to that described with respect to, and illustrated in, FIGS. 2 through 4. In some examples, aspects of the operations of 910 may be performed by a response waveform component 730 as described with reference to FIG. 7.

Implementation examples are described in the following numbered clauses:
Aspect 1: A method for wireless communications at a wireless device, comprising: receiving an excitation waveform via a first subchannel of a plurality of subchannels of a channel bandwidth; and outputting a backscattered response waveform via a second subchannel of the plurality of subchannels of the channel bandwidth based at least in part on the excitation waveform, wherein the backscattered response waveform is based at least in part on a frequency translation of signal energy of the excitation waveform from the first subchannel to the second subchannel, and wherein the frequency translation from the first subchannel to the second subchannel indicates one or more information bits.
Aspect 2: The method of aspect 1, wherein each subchannel of the plurality of subchannels other than the first subchannel is associated with one or more information bit values.
Aspect 3: The method of any of aspects 1 through 2, wherein the frequency translation from the first subchannel to the second subchannel is an increase in frequency that is associated with a first value for an information bit of the one or more information bits or a decrease in frequency that is associated with a second value for an information bit of the one or more information bits.
Aspect 4: The method of any of aspects 1 through 3, wherein each subchannel of the plurality of subchannels corresponds to a different resource unit of a plurality of resource units included within the channel bandwidth.
Aspect 5: The method of any of aspects 1 through 4, wherein outputting the backscattered response waveform further comprises: outputting the backscattered response waveform at a first signal energy level that is one of a plurality of different signal energy levels, wherein each signal energy level of the plurality of different signal energy levels corresponds to a different value for an information bit of the one or more information bits.
Aspect 6: The method of any of aspects 1 through 5, further comprising: receiving the excitation waveform via the first subchannel over a plurality of TTIs; and outputting the backscattered response waveform into at least one subchannel of the plurality of subchannels other than the first subchannel during a time duration associated with the plurality of TTIs to indicate a sequence of the one or more information bits.
Aspect 7: The method of any of aspects 1 through 6, further comprising: transmitting a training sequence associated with an amplitude of the backscattered response waveform, wherein an amplitude threshold associated with a first bit value of the one or more information bits is based at least in part on the training sequence.
Aspect 8: The method of any of aspects 1 through 7, wherein the excitation waveform is received via the first subchannel that is a single subchannel of the plurality of subchannels of the channel bandwidth and the backscattered response waveform is backscattered in the second subchannel that is any subchannel of the plurality of subchannels other than the first subchannel.
Aspect 9: A method for wireless communications at a UE, comprising: transmitting an excitation waveform via a first subchannel of a plurality of subchannels of a channel bandwidth; and receiving a backscattered response waveform via a second subchannel of the plurality of subchannels of the channel bandwidth, wherein the backscattered response waveform is based at least in part on a frequency translation of signal energy of the excitation waveform from the first subchannel to the second subchannel, and wherein the frequency translation from the first subchannel to the second subchannel indicates one or more information bits.
Aspect 10: The method of aspect 9, wherein each subchannel of the plurality of subchannels other than the first subchannel is associated with one or more information bit values.
Aspect 11: The method of any of aspects 9 through 10, wherein the frequency translation from the first subchannel to the second subchannel is an increase in frequency that is associated with a first value for an information bit of the one or more information bits or a decrease in frequency that is associated with a second value for an information bit of the one or more information bits.
Aspect 12: The method of any of aspects 9 through 11, wherein each subchannel of the plurality of subchannels corresponds to a different resource unit of a plurality of resource units included within the channel bandwidth.
Aspect 13: The method of any of aspects 9 through 12, further comprising: transmitting the excitation waveform via the first subchannel over a plurality of TTIs; and receiving the backscattered response waveform via at least one subchannel of the plurality of subchannels other than the first subchannel during a time duration associated with the plurality of TTIs to indicate a sequence of the one or more information bits.
Aspect 14: The method of any of aspects 9 through 13, further comprising: decoding a value of an information bit of the one or more information bits from the backscattered response waveform based at least in part on a comparison of energy detected for the second subchannel relative to energy detected for one or more other subchannels of the plurality of subchannels other than the first subchannel.
Aspect 15: The method of aspect 14, further comprising: calculating an energy of the second subchannel and an energy of the one or more other subchannels based at least in part on a summation of one or more squares of one or more respective subcarrier amplitudes of the second subchannel and the one or more other subchannels.
Aspect 16: The method of any of aspects 9 through 15, wherein each subchannel of the plurality of subchannels other than the first subchannel corresponds to a value of the one or more information bits in accordance with a bit mapping, and the second subchannel is associated with a highest subchannel energy of the plurality of subchannels other than the first subchannel.
Aspect 17: The method of any of aspects 9 through 16, further comprising: decoding a value of an information bit of the one or more information bits from the backscattered response waveform based at least in part on a comparison of an amplitude of the backscattered response waveform received via the second subchannel to a threshold.
Aspect 18: The method of aspect 17, further comprising: receiving a training sequence, wherein the threshold is based at least in part on the training sequence.
Aspect 19: A wireless device for wireless communications, comprising one or more memories storing processor-executable code, and one or more processors coupled with the one or more memories and individually or collectively operable to execute the code to cause the wireless device to perform a method of any of aspects 1 through 8.
Aspect 20: A wireless device for wireless communications, comprising at least one means for performing a method of any of aspects 1 through 8.
Aspect 21: A non-transitory computer-readable medium storing code for wireless communications, the code comprising instructions executable by one or more processors to perform a method of any of aspects 1 through 8.
Aspect 22: A UE for wireless communications, comprising one or more memories storing processor-executable code, and one or more processors coupled with the one or more memories and individually or collectively operable to execute the code to cause the UE to perform a method of any of aspects 9 through 18.
Aspect 23: A UE for wireless communications, comprising at least one means for performing a method of any of aspects 9 through 18.
Aspect 24: A non-transitory computer-readable medium storing code for wireless communications, the code comprising instructions executable by one or more processors to perform a method of any of aspects 9 through 18.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described herein. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described herein as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described herein should not be understood as requiring such separation in all examples, and it should be understood that the described program components and systems can generally be integrated together in a single software product or packaged into multiple software products.

What is claimed is:

1. A wireless device, comprising:
one or more memories storing processor-executable code; and
one or more processors coupled with the one or more memories and individually or collectively operable to execute the code to cause the wireless device to:
receive an excitation waveform via a first subchannel of a plurality of subchannels of a channel bandwidth; and
output a backscattered response waveform via a second subchannel of the plurality of subchannels of the channel bandwidth based at least in part on the excitation waveform, wherein the backscattered response waveform is based at least in part on a frequency translation of signal energy of the excitation waveform from the first subchannel to the second subchannel, and wherein the frequency translation from the first subchannel to the second subchannel indicates one or more information bits.

2. The wireless device of claim 1, wherein each subchannel of the plurality of subchannels other than the first subchannel is associated with one or more information bit values.

3. The wireless device of claim 1, wherein the frequency translation from the first subchannel to the second subchannel is an increase in frequency that is associated with a first value for an information bit of the one or more information bits or a decrease in frequency that is associated with a second value for an information bit of the one or more information bits.

4. The wireless device of claim 1, wherein each subchannel of the plurality of subchannels corresponds to a different resource unit of a plurality of resource units included within the channel bandwidth.

5. The wireless device of claim 1, wherein, to output the backscattered response waveform, the one or more processors are individually or collectively further operable to execute the code to cause the wireless device to:
output the backscattered response waveform at a first signal energy level that is one of a plurality of different signal energy levels, wherein each signal energy level of the plurality of different signal energy levels corresponds to a different value for an information bit of the one or more information bits.

6. The wireless device of claim 1, wherein the one or more processors are individually or collectively further operable to execute the code to cause the wireless device to:
receive the excitation waveform via the first subchannel over a plurality of transmission time intervals (TTIs); and
output the backscattered response waveform into at least one subchannel of the plurality of subchannels other than the first subchannel during a time duration associated with the plurality of TTIs to indicate a sequence of the one or more information bits.

7. The wireless device of claim 1, wherein the one or more processors are individually or collectively further operable to execute the code to cause the wireless device to:
transmit a training sequence associated with an amplitude of the backscattered response waveform, wherein an amplitude threshold associated with a first bit value of the one or more information bits is based at least in part on the training sequence.

8. The wireless device of claim 1, wherein the excitation waveform is received via the first subchannel that is a single subchannel of the plurality of subchannels of the channel bandwidth and the backscattered response waveform is backscattered in the second subchannel that is any subchannel of the plurality of subchannels other than the first subchannel.

9. A user equipment (UE), comprising:
one or more memories storing processor-executable code; and
one or more processors coupled with the one or more memories and individually or collectively operable to execute the code to cause the UE to:
transmit an excitation waveform via a first subchannel of a plurality of subchannels of a channel bandwidth; and
receive a backscattered response waveform via a second subchannel of the plurality of subchannels of the channel bandwidth, wherein the backscattered response waveform is based at least in part on a frequency translation of signal energy of the excitation waveform from the first subchannel to the second subchannel, and wherein the frequency translation from the first subchannel to the second subchannel indicates one or more information bits.

10. The UE of claim 9, wherein each subchannel of the plurality of subchannels other than the first subchannel is associated with one or more information bit values.

11. The UE of claim 9, wherein the frequency translation from the first subchannel to the second subchannel is an increase in frequency that is associated with a first value for an information bit of the one or more information bits or a decrease in frequency that is associated with a second value for an information bit of the one or more information bits.

12. The UE of claim 9, wherein each subchannel of the plurality of subchannels corresponds to a different resource unit of a plurality of resource units included within the channel bandwidth.

13. The UE of claim 9, wherein the one or more processors are individually or collectively further operable to execute the code to cause the UE to:
transmit the excitation waveform via the first subchannel over a plurality of transmission time intervals (TTIs); and
receive the backscattered response waveform via at least one subchannel of the plurality of subchannels other than the first subchannel during a time duration associated with the plurality of TTIs to indicate a sequence of the one or more information bits.

14. The UE of claim 9, wherein the one or more processors are individually or collectively further operable to execute the code to cause the UE to:
decode a value of an information bit of the one or more information bits from the backscattered response waveform based at least in part on a comparison of energy detected for the second subchannel relative to energy detected for one or more other subchannels of the plurality of subchannels other than the first subchannel.

15. The UE of claim 14, wherein the one or more processors are individually or collectively further operable to execute the code to cause the UE to:
calculate an energy of the second subchannel and an energy of the one or more other subchannels based at least in part on a summation of one or more squares of one or more respective subcarrier amplitudes of the second subchannel and the one or more other subchannels.

16. The UE of claim 9, wherein:
each subchannel of the plurality of subchannels other than the first subchannel corresponds to a value of the one or more information bits in accordance with a bit mapping, and
the second subchannel is associated with a highest subchannel energy of the plurality of subchannels other than the first subchannel.

17. The UE of claim 9, wherein the one or more processors are individually or collectively further operable to execute the code to cause the UE to:
decode a value of an information bit of the one or more information bits from the backscattered response waveform based at least in part on a comparison of an amplitude of the backscattered response waveform received via the second subchannel to a threshold.

18. The UE of claim 17, wherein the one or more processors are individually or collectively further operable to execute the code to cause the UE to:
receive a training sequence, wherein the threshold is based at least in part on the training sequence.

19. A method for wireless communications at a wireless device, comprising:
receiving an excitation waveform via a first subchannel of a plurality of subchannels of a channel bandwidth; and
outputting a backscattered response waveform via a second subchannel of the plurality of subchannels of the channel bandwidth based at least in part on the excitation waveform, wherein the backscattered response waveform is based at least in part on a frequency translation of signal energy of the excitation waveform from the first subchannel to the second subchannel, and wherein the frequency translation from the first subchannel to the second subchannel indicates one or more information bits.

20. The method of claim 19, wherein each subchannel of the plurality of subchannels other than the first subchannel is associated with one or more information bit values.

21. The method of claim 19, wherein the frequency translation from the first subchannel to the second subchannel is an increase in frequency that is associated with a first value for an information bit of the one or more information bits or a decrease in frequency that is associated with a second value for an information bit of the one or more information bits.

22. The method of claim 19, wherein each subchannel of the plurality of subchannels corresponds to a different resource unit of a plurality of resource units included within the channel bandwidth.

23. The method of claim 19, wherein outputting the backscattered response waveform further comprises:
outputting the backscattered response waveform at a first signal energy level that is one of a plurality of different signal energy levels, wherein each signal energy level of the plurality of different signal energy levels corresponds to a different value for an information bit of the one or more information bits.

24. The method of claim 19, further comprising:
transmitting a training sequence associated with an amplitude of the backscattered response waveform, wherein an amplitude threshold associated with a first bit value of the one or more information bits is based at least in part on the training sequence.

25. A method for wireless communications at a user equipment (UE), comprising:
transmitting an excitation waveform via a first subchannel of a plurality of subchannels of a channel bandwidth; and
receiving a backscattered response waveform via a second subchannel of the plurality of subchannels of the channel bandwidth, wherein the backscattered response waveform is based at least in part on a frequency translation of signal energy of the excitation waveform from the first subchannel to the second subchannel, and wherein the frequency translation from the first subchannel to the second subchannel indicates one or more information bits.

26. The method of claim 25, further comprising:
decoding a value of an information bit of the one or more information bits from the backscattered response waveform based at least in part on a comparison of energy detected for the second subchannel relative to energy detected for one or more other subchannels of the plurality of subchannels other than the first subchannel.

27. The method of claim 26, further comprising:
calculating an energy of the second subchannel and an energy of the one or more other subchannels based at least in part on a summation of one or more squares of one or more respective subcarrier amplitudes of the second subchannel and the one or more other subchannels.

28. The method of claim 25, wherein:
each subchannel of the plurality of subchannels other than the first subchannel corresponds to a value of the one or more information bits in accordance with a bit mapping, and
the second subchannel is associated with a highest subchannel energy of the plurality of subchannels other than the first subchannel.

29. The method of claim 25, further comprising:
decoding a value of an information bit of the one or more information bits from the backscattered response waveform based at least in part on a comparison of an amplitude of the backscattered response waveform received via the second subchannel to a threshold.

30. The method of claim 29, further comprising:
receiving a training sequence, wherein the threshold is based at least in part on the training sequence.
